(19) United States
(12) Patent Application Publication
(10) Pub. No.: US 2022/0187582 A1
(43) Pub. Date: Jun. 16, 2022

(54) HIGH THROUGHPUT LENSLESS IMAGING METHOD AND SYSTEM THEREOF

(71) Applicant: NATIONAL CENTRAL UNIVERSITY, Taoyuan City (TW)

(72) Inventors: CHEN HAN HUANG, Taoyuan City (TW); CHUN SAN TAI, Taoyuan City (TW); TING YI LIN, Taoyuan City (TW)

(73) Assignee: NATIONAL CENTRAL UNIVERSITY, Taoyuan City (TW)

(21) Appl. No.: 17/543,731

(22) Filed: Dec. 7, 2021

Related U.S. Application Data
(60) Provisional application No. 63/124,232, filed on Dec. 11, 2020.

(51) Int. Cl. G02B 21/00; G02B 21/36

(52) U.S. Cl. CPC G02B 21/0032; G02B 21/0072; G02B 21/361

(57) ABSTRACT

A high throughput lensless imaging method and system thereof are provided. The system mainly includes a light source, an optical panel, and an optical image sensing module. The light source is used to generate light with a specific wavelength to illuminate. The optical panel corresponds to the light source and includes an optical pinhole that corresponds to the light source such that the light generated by the light source passes through the optical pinhole. The position of the optical image sensing module corresponds to the other surface of the optical panel, and the optical image sensing module includes a sensing unit to receive an optical diffraction signal formed after the light source illuminates an object. The sensing unit is electrically connected to a computing unit that is used to compute after receiving the optical diffraction signal transmitted by the sensing unit, so as to perform the computation and reconstruction of an image.

### BACKGROUND OF THE INVENTION

### 1. Field of the Invention

The present invention is related to an imaging technique, and particularly to an imaging system and method thereof without a lens structure.

### 2. Description of Related Art

An optical microscope plays a significant role in engineering physics, biomedicine, etc. By implementing the optical microscope, surface structure, cells, or a microorganism, etc. that cannot be seen by the naked eye may be observed. Further, in laboratory medicine, many major hospitals rely greatly on optical imaging techniques to diagnose diseases, including various types of cancer and infectious diseases, by examining biopsy or blood smear to determine whether there are pathological changes in the cells.

The basic structure and principle of a conventional optical microscope mainly include an eyepiece (or called an ocular lens) and objective lenses as well as other components, such as a reflector and aperture, together to image an object. The eyepiece is the lens close to the eye that magnifies the image of the object by the focused light using a convex lens, for ease of observation. In general, the eyepiece generally has a longer focal length compared to the objective lenses. Further, the objective lenses are the lenses close to the object that are also convex lenses for a magnified image, and the objective lenses allow the object to present a magnified virtual image by the focused light. The optical microscopes typically provide a set of three objective lenses to select from for being as close to the object as possible.

Usually, in the use of an optical microscope, an objective lens with a lower magnifying power is first used, which offers a wide field of view to easily find the object to be observed. In other aspects, the length of the objective lens with a lower magnifying power is shorter, so the distance between the objective lens and the object is longer, which allows more space to manipulate so as to prevent the direct contact between the object lens and the observed object from damaging the object.

However, although the optical microscope has been invented for a long time and the convenience thereof goes without saying, its feasible applications are limited due to the complexity and expensive costs of the optical imaging devices. Further, the optical microscope requires trained professional laboratory personnel to operate, which limits the wider usage of the optical imaging devices, especially in remote regions with limited resource.

### SUMMARY OF THE INVENTION

According to the above shortcomings, the main object of the present invention is to provide a high throughput lensless imaging system and method thereof that simplify the optical imaging equipment by utilizing scalar diffraction theory. The system includes non-coherent light, an optical pinhole, and an optical image sensor without bulk and complex optical components by removing the lenses, which limit the field of view (FOV), to achieve a wider FOV and attain images with the micrometer-scale resolution. In the present invention, an optical diffraction signal is recorded on a sensor by controlling the spatial coherence of a light source, an image having the resolution, which is the same as a 20x microscope, is reconstructed by Fourier transform without an optical lens, and, by a programming algorithm, the final optimized image is rendered in a short period of time as a result.

To achieve the aforementioned object, the present invention mainly provides a high throughput lensless imaging method and system thereof. The system mainly includes a light source, an optical panel, and an optical image sensing module. The light source is used to generate light with a specific wavelength to illuminate. The optical panel corresponds to the light source and is provided with an optical pinhole that corresponds to the light source such that the light generated by the light source passes through the optical pinhole. The position of the optical image sensing module corresponds to the other surface of the optical panel, and the optical image sensing module further includes a sensing unit to receive an optical diffraction signal formed after the light source illuminates an object. The sensing unit is electrically connected to a computing unit that is used to compute after receiving the optical diffraction signal transmitted by the sensing unit, so as to perform the computation and reconstruction of an image.

To make the above description and other objects, features, and advantages of the present invention more apparent and understandable, preferred embodiments are made in the following with reference to the accompanying drawings as the detailed description.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a structural view of the present invention.

FIG. 2 is a block diagram of the structure of an optical image sensing module according to the present invention.

FIG. 3 is an imaging illustration according to the principle of the present invention.

FIG. 4 is a flowchart according to the imaging method of the present invention.

FIG. 5 is a perspective view of the present invention.

FIG. 6 is cell imaging photos A, B, C of the present invention.

### DETAILED DESCRIPTION OF THE PREFERRED EMBODIMENT

These and other aspects of the embodiments herein will be better appreciated and understood when considered in conjunction with the following description and the accompanying drawings.

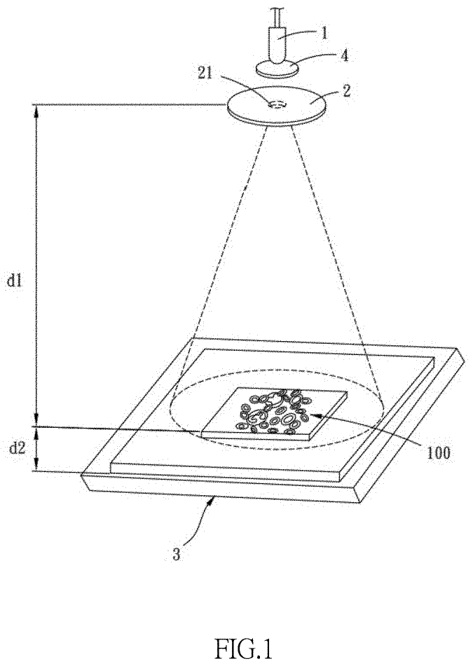

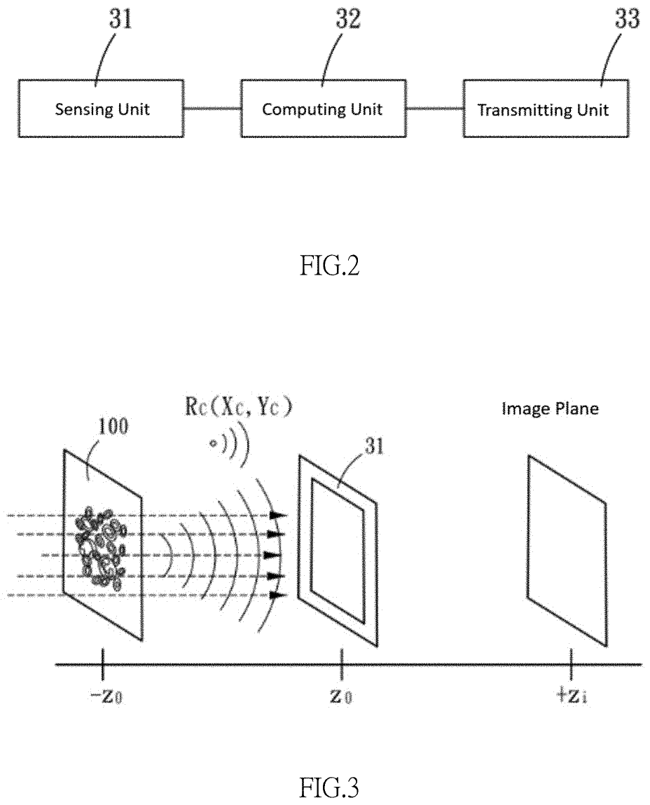

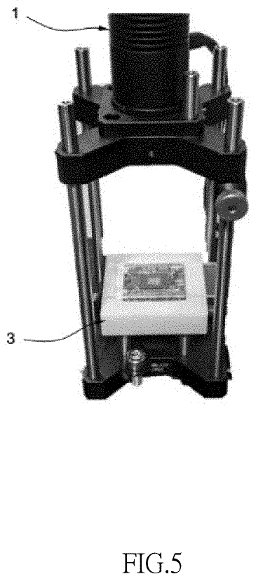

Referring to FIG. 1, a structural view of the present invention is shown. A high throughput lensless imaging system of the present invention is developed by utilizing Fresnel-Kirchoff s diffraction formula. In the diffraction theory, the complex amplitude at any one of points in a light field can be represented by the complex amplitude at other points in the light field, i.e., the complex amplitude at any one of the points behind a hole can be calculated by the light field distribution on the plane of the hole. Kirchhoff s integral theorem is widely used in the optical field and is close to different diffraction formulas according to different situations. As shown in drawing, the system of the present invention mainly includes a light source 1, an optical panel 2 and an optical image sensing module 3. In this embodiment, the light source 1 is a lighting device for generating light with a specific wavelength, and the wavelength (color) of the light generated by the light source 1 is changeable. Alternatively, the light source 1 having a long range of wavelengths (e.q., white light) can be used, and an optical filter 4 is installed to select a wavelength after the light source 1 illuminates the light. In addition, in this embodiment, the light source is a stationary light source, as shown in the perspective view of FIG. 5. One surface (also called a first surface) of the optical panel 2 corresponds to the light source. The optical panel 2 includes an optical pinhole 21, and the size of the optical pinhole 21 is in the micrometer scale. The optical pinhole 21 corresponds to the light source 1 and allows the light generated by the light source 1 to pass through the optical pinhole 21. The position of the optical image sensing module 3 corresponds to the other surface (also called a second surface) of the optical panel 2, and the optical image sensing module 3 is used to receive a reference light generated after the light from the light source 1 illuminates on the object 100 so as to compute an optical diffraction signal. The optical image sensing module 3 includes a sensing unit 31. As shown in FIG. 2, which is a block diagram of the structure of the optical image sensing module, the sensing unit 31, in this embodiment, is an optical image sensor to receive the optical diffraction signal formed after the light from the light source 1 illuminates on the object 100. The sensing unit 31 is electrically connected to a computing unit 32 that, in this embodiment, is a microcontroller having a programming algorithm. The computing unit 32 is used to compute after receiving the optical diffraction signal transmitted by the sensing unit 31 so as to perform the image computation and reconstruction. The optical image sensing module 3 further includes a transmitting unit 33 that, in this embodiment, is a signal transmitting device such as a network server or a Bluetooth module. The transmitting unit 33 is electrically connected to the computing unit 32 to transmit the results computed by the computing unit 32 to an external device.

In addition, as shown in FIG. 1, the object 100 is placed in the system of the present invention such that the relative distance between the surface on which the object 100 is placed and the optical panel 2 is kept at “d1”, and the relative distance between the surface on which the object 100 is placed and the optical image sensing module 3 is kept at “d2”. The illumination area generated by the light source 1 equals to the surface area of the sensing unit 31. The above-mentioned light source 1, optical filter 4, optical panel 2 and the optical image sensing module 3 may be secured by a rigid frame.

Referring to FIG. 3, an imaging illustration according to the principle of the present invention is shown. An image sensor, such as CCD, CMOS, etc., is utilized in the present invention for recording optical signals. In the image reconstructing process, the optical signals are received by the image sensor without an optical lens system. The received optical signals are converted into an array of digital signals, by which an optical transfer process is computed and simulated by a computer. In the simulation, the amplitude and phase of an object are represented in the form of a complex number so as to render the digitalized wave of the object. FIG. 3 illustrates the imaging principle of the present invention by the digital image reconstructing principle of Fresnel signals. The reference light and the light scattered from the object are incident on the surface of the sensing unit 31 in the same direction, which satisfies the condition of Fresnel near-field diffraction area. After the reference light generated by the light source 1 illuminates on the object 100, the reference light and the light scattered from the object 100 are incident on the surface of the sensing unit 31 in the same direction. Where, -Z0 is the location of the object, Z0 is the location of the image sensing unit, U(x,y) is the object light that reaches the surface of the sensing unit 31, and Z0 is the distance between the surface on which the object 100 is placed and the sensing unit 31. According to Fresnel diffraction equation, the object light that reaches the surface of the sensing unit 31 can be expressed as:

$$U ( x , y ) = \int {\int }_{- ∞}^{∞} O ( {x}_{0} , {y}_{0} ) \cdot exp \{ j \frac{k}{2 {z}_{0}} [ {( x - {x}_{0} )}^{2} + {( y - {y}_{0} )}^{2} ] \} d {x}_{0} d {y}_{0}$$

The reference light that reaches the surface of the sensing unit 31 can be expressed as:

$$R ( x , y ) = {R}_{0} exp \{ j \frac{k}{2 {z}_{r}} [ {( x - {x}_{r} )}^{2} + {( y - {y}_{r} )}^{2} ] \}$$

The luminous intensity on the sensing unit 31 can be expressed as:

I(x,y)=[U(x,y)+R(x,y)]²=|U(x,y)|²+R₀²+U(x,y)R*(x,y)+U*(x,y)R(x,y)

Where, |U |² and R₀² are zero-order diffraction that contains information of the amplitude. UR* and U*R are the interference terms between the object light wave and the reference light wave, in which UR* is directly associated with the object and includes the phrase of its wave, and U*R is a conjugate wave of the object that renders the virtual image and real image of the object, respectively.

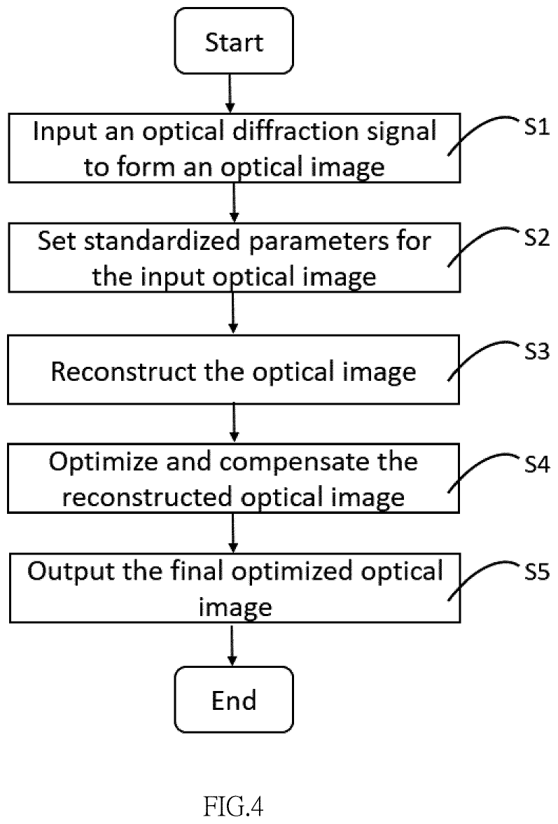

Referring to FIG. 4, a flowchart according to the imaging method of the present invention is shown. As shown in the drawing, the steps include:

inputting an optical diffraction signal to form an optical image (S1), and the optical diffraction signal is generated after the light from the light source 1 illuminates on the object 100, and the signal is received by the sensing unit 31 to form the optical image;

setting standardized parameters for the input optical image (S2), and these standardized parameters are used for the adjustments of the image and the process of wave filtering, which include image signal processing such as brightness, contrast, intensity distribution, noise reduction, and edge enhancement, and the adjustments of the brightness, contrast, intensity distribution, noise reduction, and edge enhancement of the current image signals with a commonly used ratio are used as a reference to adjust these standardized parameters accordingly;

reconstructing the optical image (S3), and the reconstruction includes a Fourier transform to reconstruct the image;

optimizing and compensating the reconstructed optical image (S4), and the optimization and compensation, in this embodiment, utilizes backpropagation method that computes the gradient of the loss function with respect to the weights of the reconstructed optical image and outputs the optimized strategy as feedback; and

outputting the final optimized optical image (S5).

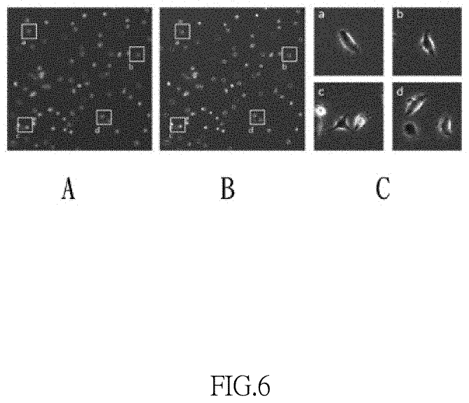

Cell imaging photos A, B, C of FIG. 6 are shown according to the system and imaging method of the present invention. In the photo A of FIG. 6, after optical diffraction signals are generated using the imaging principle of the present invention, the image signals are adjusted by the system, which performs the image signal processing including brightness, contrast, intensity distribution, noise reduction, edge enhancement, etc. As shown in the photo B of FIG. 6, points a-d are selected in the image. As shown in the photo C of FIG. 6, the images of the points a-d are magnified, and the final images are formed after the magnified images of the points a-d are optimized.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A high throughput lensless imaging system, comprising:
a light source, and a wavelength generated by the light source being changeable;
an optical panel including a first surface, a second surface and an optical pinhole, and the first surface of the optical panel corresponding to the light source, the optical pinhole corresponding to the light source such that the light generated by the light source passes through the optical pinhole; and
an optical image sensing module, and a position thereof corresponding to the second surface of the optical panel to receive a reference light generated after a light from the light source illuminates on an object via the optical pinhole in order to compute a diffraction image, and the optical image sensing module including:
a sensing unit for receiving an optical diffraction signal generated after the light from the light source illuminates on the object; and
a computing unit electrically connected to the sensing unit and used to receive the optical diffraction signal transmitted by the sensing unit, so as to perform image calculation and reconstruction.

2. The high throughput lensless imaging system of claim 1, wherein the light source is light source with a long wavelength.

3. The high throughput lensless imaging system of claim 1, further comprising an optical filter, wherein the optical filter is disposed between the light source and the optical panel and used to select the wavelength after the light illuminates on the object.

4. The high throughput lensless imaging system of claim 1, wherein size of the optical pinhole is in micrometer scale.

5. The high throughput lensless imaging system of claim 1, wherein the sensing unit is an optical image sensor.

6. The high throughput lensless imaging system of claim 1, wherein the computing unit is a microcontroller having a programming algorithm.

7. The high throughput lensless imaging system of claim 1, wherein the optical image sensing module further includes a transmitting unit that is electrically connected to the computing unit to transmit results computed by the computing unit to an external device.

8. The high throughput lensless imaging system of claim 7, wherein the transmitting unit is a signal transmitting device.

9. The high throughput lensless imaging system of claim 8, wherein the signal transmitting device is a network server or a Bluetooth module.

10. The high throughput lensless imaging system of claim 1, wherein illumination area formed by the light source equals to surface area of the sensing unit.

11. The high throughput lensless imaging system of claim 1, wherein the light source is a stationary light source.

12. A high throughput lensless imaging method, comprising steps of:
a. inputting an optical diffraction signal to form an optical image;
b. setting standardized parameters for the optical image;
c. reconstructing the optical image;
d. optimizing and compensating the optical image; and
e. outputting the optical image.

13. The high throughput lensless imaging method of claim 12, wherein in the step of b, the standardized parameters include brightness, contrast, intensity distribution, noise reduction, edge enhancement for image signal processing.

14. The high throughput lensless imaging method of claim 12, wherein in the step of c, the reconstruction includes a Fourier transform to reconstruct the optical image.

15. The high throughput lensless imaging method of claim 12, wherein the step of d utilizes backpropagation method.
